(19) United States
(12) Patent Application Publication
(10) Pub. No.: US 2006/0188303 A1
(43) Pub. Date: Aug. 24, 2006

(54) Imaging apparatus

(76) Inventor: Jun Takahashi, Chiba (JP)

Correspondence Address: HARNESS, DICKEY & PIERCE, P.L.C., P.O. BOX 8910, RESTON, VA, 20195, US

(21) Appl. No.: 11/358,080

(22) Filed: Feb. 22, 2006

(30) Foreign Application Priority Data
Feb. 22, 2005 (JP) 2005-045921

(51) Int. Cl. G03G 21/00

(52) U.S. Cl. 399/366

(57) ABSTRACT

An imaging apparatus is disclosed that is operated by an operator and is configured to execute an imaging operation involving reading an original document. The apparatus includes a pattern detecting unit configured to determine whether a pattern is printed on the original document, and user information registering an authorized user name of an authorized user that is authorized to direct the execution of the imaging operation in a case where the pattern is detected from the original document by the pattern detecting unit. The execution of the imaging operation is controlled in a case where the pattern is detected from the original document and the operator does not correspond to the authorized user with the authorized user name registered in the user information.

### BACKGROUND OF THE INVENTION

1. Field of the Invention

The present invention relates to an imaging apparatus realizing access control.

2. Description of the Related Art

As the copying performance of an imaging apparatus such as a copying machine is improved and various additional functions are realized, access control of the imaging apparatus becomes important. For example, owing to the development of copying technology, a copying machine nowadays is capable of making copies that are almost undistinguishable from the original document, and thereby, in a case where a highly confidential document is subject to copying, proper measures have to be taken to protect such a document.

If an outsider with malicious intent may make copies of a highly confidential document and take the copies outside, for example, confidential information may be leaked. When such unauthorized use of a confidential document through copying takes place, it is generally impossible to determine when, by whom, and with which imaging apparatus such copying was performed. In consideration of such a problem, access authority may be established for each individual user, for example. However, in such a case, access control of the imaging apparatus may be burdensome. It is noted that access control may also be burdensome in the case of charging fees for an imaging operation or counting imaging operations performed by each user, for example.

### SUMMARY OF THE INVENTION

According to a preferred embodiment of the present invention, an imaging apparatus is provided that is capable of preventing unauthorized use through simple measures.

More specifically, according to one preferred embodiment of the present invention, an imaging apparatus is provided that is operated by an operator and is configured to execute an imaging operation involving reading an original document, the apparatus including:

a pattern detecting unit configured to determine whether a pattern is printed on the original document; and

user information registering an authorized user name of an authorized user that is authorized to direct the execution of the imaging operation in a case where the pattern is detected from the original document by the pattern detecting unit; wherein

the execution of the imaging operation is controlled in a case where the pattern is detected from the original document and the operator does not correspond to the authorized user with the authorized user name registered in the user information.

According to one preferred embodiment of the present invention, the user information registers a group name of a group of one or more of the authorized users as the authorized user name.

According to another preferred embodiment of the present invention, an imaging apparatus is provided that is operated by an operator and is configured to execute an imaging operation involving reading an original document, the apparatus including:

a pattern detecting unit configured to determine whether a pattern is printed on the original document; and

a superposing unit configured to superpose information pertaining to the operator directing the execution of the imaging operation on read data obtained by reading the original document in a case where the pattern is detected from the original document by the pattern detecting unit.

According to another preferred embodiment of the present invention, an imaging apparatus is provided that is configured to execute an imaging operation involving reading an original document, the apparatus including:

a pattern detecting unit configured to determine whether a pattern is printed on the original document; and

fee information registering the pattern in association with a corresponding fee; wherein

when the pattern is detected by the pattern detecting unit, the corresponding fee is obtained from the fee information and the corresponding fee is charged.

According to another preferred embodiment of the present invention, an imaging apparatus is provided that is configured to execute an imaging operation involving reading an original document, the apparatus including:

a pattern detecting unit configured to determine whether a pattern is printed on the original document; wherein

when the pattern is detected from the original document by the pattern detecting unit, counter information including information pertaining to a number of executions of the imaging operation is changed.

### BRIEF DESCRIPTION OF THE DRAWINGS

FIG.1 is a block diagram showing a software configuration of a multifunction printer as an imaging apparatus according to an embodiment of the present invention;

FIG. 2 is a block diagram showing a hardware configuration of the multifunction printer of FIG. 1;

FIG. 3 is a table illustrating a user registration database;

FIG. 4 is a flowchart illustrating a process for preventing the execution of unauthorized imaging operations;

FIG. 5 is a flowchart illustrating an imaging process involving superposing additional information;

FIG. 6 is a table illustrating a fee pattern database;

FIG. 7 is a flowchart illustrating a process for charging a fee according to a detected pattern; and

FIG. 8 is a table illustrating counter information.

### DESCRIPTION OF THE PREFERRED EMBODIMENTS

In the following, preferred embodiments of the present invention are described with reference to the accompanying drawings. It is noted that a MFP (multifunction printer) is illustrated as an imaging apparatus according to a preferred embodiment of the present invention. Also, copier, fax, and scanner operations may collectively be referred to as imaging operations.

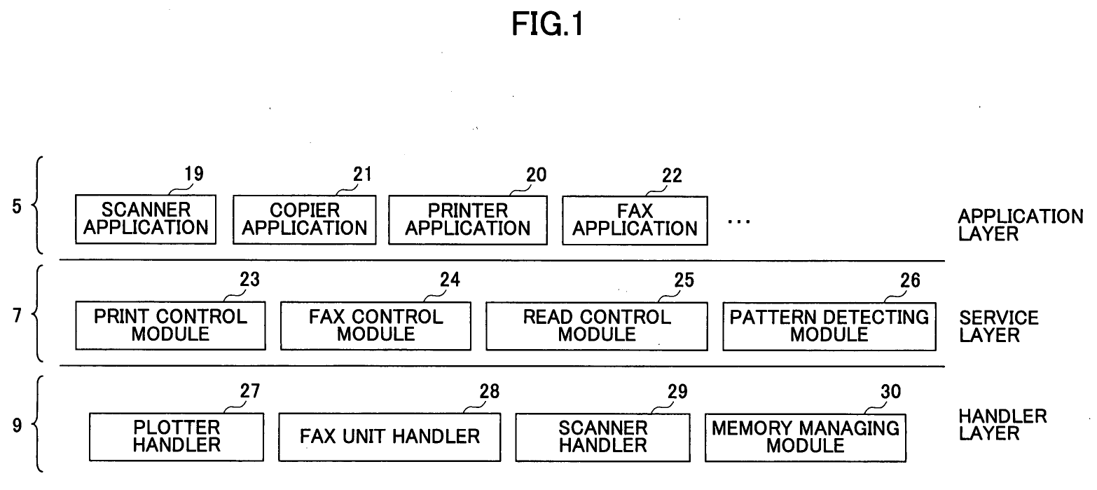

FIG. 1 is a block diagram illustrating a software configuration of a MFP according to an embodiment of the present invention. It is noted that applications, modules, and handlers shown in FIG. 1 may collectively be referred to as programs.

The software configuration of FIG. 1 is divided into three layers; namely, an application layer 5, a service layer 7, and a handler layer 9. The application layer 5 includes programs such as a scanner application 19, a copier application 21, a printer application 20, and a fax application 22. The service layer 7 includes programs such as a print control module 23, a fax control module 24, a read control module 25, and a pattern detecting module 26. The handler layer 9 includes programs such as a plotter handler 27, a fax unit handler 28, a scanner handler 29, and a memory managing module 30.

The scanner application 19, the copier application 21, the printer application 20, and the fax application 22 of the application layer 5 correspond to applications for a scanner function, a copier function, a printer function, and a fax function, respectively. These applications are configured for executing corresponding imaging operations and superposing additional information on data read from an original document, for example.

The modules of the service layer 7 are configured for controlling operation processes executed in the MFP. Specifically, the print control module 23 is configured for controlling a print process. The fax control module 24 is configured for controlling a fax process. The read control module 25 is configured for controlling a read process. The pattern detecting module 26, corresponding to a pattern detecting unit according to a preferred embodiment of the present invention, is configured for detecting a pattern (described in detail below) according to a request from one of the applications of the application layer 5, and transmitting the detection result as a response.

The programs of the handler layer 9 are configured for handling hardware components of the MFP such as a plotter and a scanner.

The plotter handler 27 is configured for handling the plotter. The fax unit handler 28 is configured for handling a fax unit. The scanner handler 29 is configured for handling the scanner. The memory managing module 30 is configured for handling a memory and a hard disk, for example.

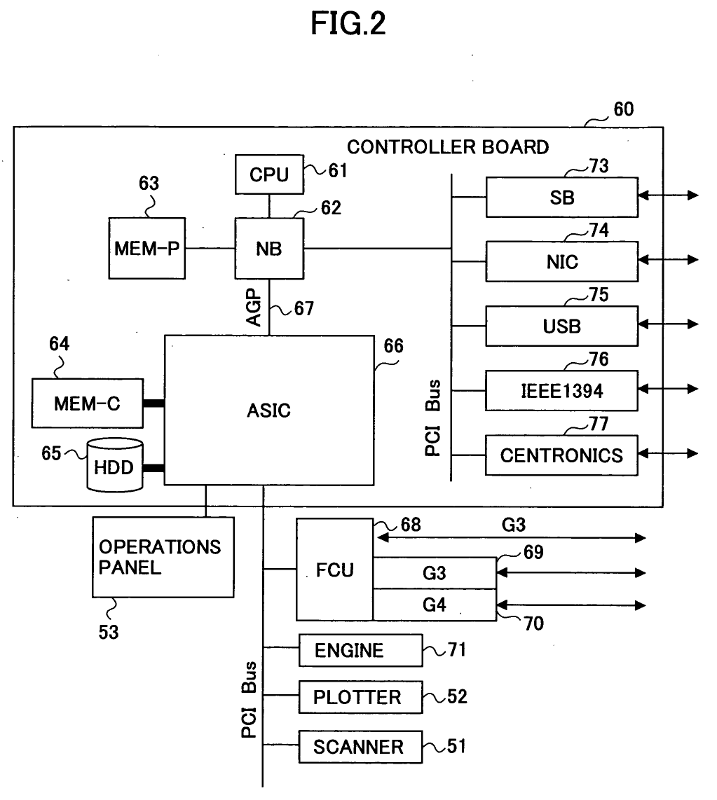

FIG. 2 is a block diagram showing a hardware configuration of the MFP. As is shown in this drawing, the MFP includes a controller board 60, an operations panel 53, a FCU 68, an engine 71, a scanner 51, and a plotter 52. The FCU 68 includes a G3 standard compatible unit 69 and a G4 standard compatible unit 70.

The controller board 60 includes a CPU 61, an ASIC 66, a HDD 65, a local memory (MEM-C) 64, a system memory (MEM-P) 63, a North Bridge (NB) 62, a South Bridge (SB) 73, a NIC (Network Interface Card) 74, a USB device 75, an IEEE 1394 device 76, and a Centronics device 77.

The operations panel 53 is connected to the ASIC 66 of the controller board 60. The operations panel 53 is also connected to the SB 72, the NIC 74, the USB device 75, the IEEE 1394 device 76, the Centronics device 77, and the NB 62 via a PCI bus.

The FCU 68, the engine 71, the scanner 51, and the plotter 52, are connected to the ASIC 66 of the controller board 60 via a PCI bus.

In the controller board 60, the local memory 64 and the HDD 65 are connected to the ASIC 66, and the CPU 61 and the ASIC 66 are interconnected via the NB 62 corresponding to a CPU chip set. By arranging the CPU 61 and the ASIC 66 to be interconnected via the NB 62, the controller board 60 may be adapted for a case in which the interface of the CPU 61 is not disclosed.

It is noted that the ASIC 66 and the NB 62 are interconnected via an AGP (Accelerated Graphics Port) 67 instead of a PCI bus. By interconnecting the ASIC 66 and the NB 62 with the AGP 67 that realizes higher connection speed compared to the PCI bus, performance degradation may be prevented in execution control of one or more processes realizing the application layer 5 shown in FIG. 1, for example.

The CPU 61 controls the overall operations of the MFP. The CPU 61 is configured to activate and execute the programs included in the application layer 5, the service layer 7, and the handler layer 9 as processes on an OS.

The NB 62 is configured to interconnect the CPU 61, the system memory 63, the SB 73, and the ASIC 66. The system memory 63 may be used as a depiction memory of the MFP, for example. The SB 73 is configured to interconnect the NB 62, the PCI bus, and peripheral devices. The local memory 64 may be used as a copying image buffer and a code buffer, for example.

The ASIC 66 is an IC adapted for image processing that includes image processing hardware elements. The HDD 65 is a storage device for storing image data, document data, programs, and font data, for example. The operations panel 53 is configured to receive input operations from a user and display information directed to the user, for example.

In the present embodiment, it is assumed that the MFP is arranged to register information on users beforehand, and a user (operator) is required to perform a login operation before operating the MFP.

In the following, pattern detection according to an embodiment of the present invention is described. A pattern refers to an object printed on an original document that may be read by the MFP. For example, a pattern may correspond to a geometric figure such as a star shape. In such a case, different patterns may be represented by varying the shapes of the geometric figure, for example.

In another example, the pattern may correspond to dots printed on a predetermined position of the original document. In such a case, different patterns may be represented by varying the dot density of the dot pattern, for example.

In the following, exemplary processes that rely on pattern detection are described. First, a process for preventing the execution of unauthorized imaging operations according to one embodiment of the present invention is described. Specifically, this process involves prohibiting the execution of an imaging operation by a user when a pattern is detected and the user is not registered (authorized) to execute such an imaging operation.

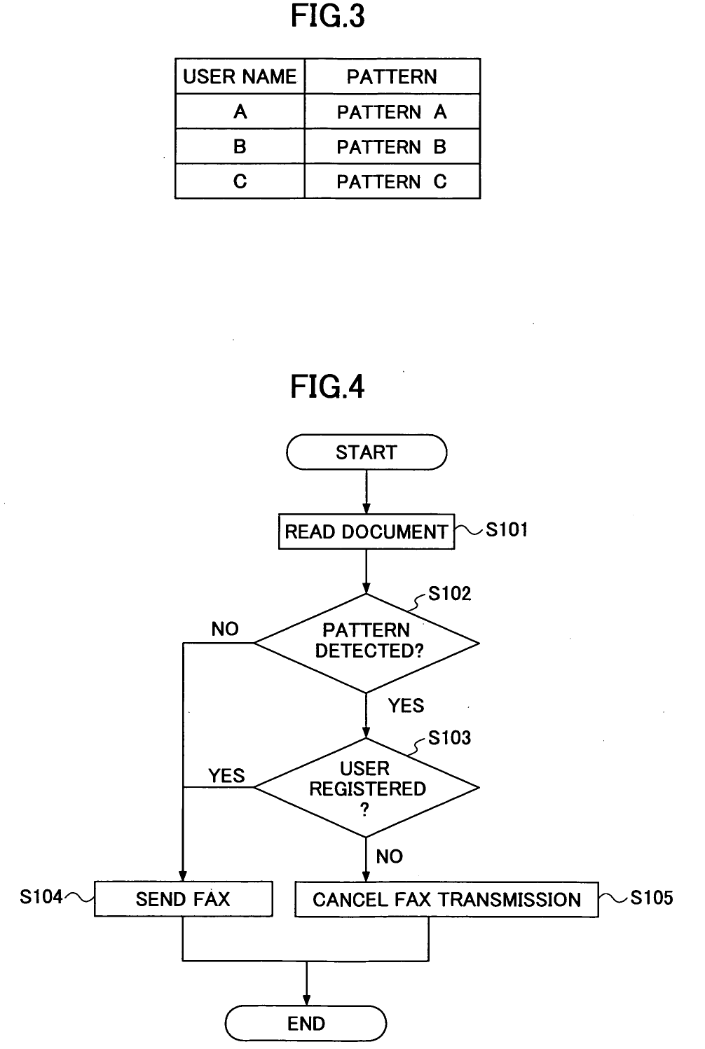

FIG. 3 is a table illustrating a user registration database (DB) in which user names are registered in association with their corresponding user patterns. It is noted that the user registration DB corresponds to user information according to an embodiment of the present invention. The illustrated user registration DB includes a user name and a corresponding pattern as entry items. For example, it may be appreciated from the illustrated user registration DB that pattern A is the corresponding pattern for user A. In another example, when the pattern for all users is the same, the user registration DB may simply register user names of users.

FIG. 4 is a flowchart illustrating an exemplary process executed by the fax application 22 for prohibiting a fax operation. In this process, first, in step S101, an original document to be transmitted is read (e.g., scanned). Then, in step S102, a determination is made as to whether a pattern is detected. If no pattern is detected, the corresponding fax is transmitted in step S104.

If a pattern is detected in step S102, a determination is made as to whether the current user (operator) of the MFP corresponds to a registered user authorized to direct the execution of the corresponding fax transmission (step S103). Specifically, the fax application 22 may refer to the user registration DB to make this determination. If it is determined that the user is not registered as an authorized user, the fax transmission is canceled (step S105). If it is determined that the user is registered as an authorized user, the corresponding fax is transmitted (step S104).

It is noted that the process of FIG. 4 illustrates a case of performing fax transmission; however, this process flow may also be applied to other imaging operations such as copying or scanning, for example. In such cases, a copying operation or a scanning operation may be performed (step S104) or cancelled (step S105) instead of performing/canceling the fax transmission.

Also, it is noted that in the above illustrated example, the user registration DB is arranged to register users individually. However, the present invention is not limited to such an example, and users may be registered in group units according to another example. In this case, access authority may be established for each group as opposed to each individual user so that access control may be simplified.

Also, in the illustrated example, the fax transmission is canceled in step S105. However, the present invention is not limited to such an example, and the read image may be destroyed in another example. Image destroying refers to a process of disabling accurate reading of the original document by arranging the corresponding read data of the original document to be output as a totally black image, for example. In this way, copying of a highly confidential document may be prevented, for example. It is noted that image destroying implemented in the case of performing a fax operation may correspond to transmitting a totally black image, and image destroying implemented in the case of performing a scanning operation may correspond to storing a totally black image as the scanned data, for example.

As can be appreciated from the above descriptions, by performing the process of preventing the execution of unauthorized operations according to an embodiment of the present invention, only a registered authorized user may be able to execute imaging operations of an original document that has a pattern printed thereon, and in this way, outsiders may be prevented from realizing imaging operations such as copying of confidential documents, for example.

In the following, a process according to another embodiment is described in which a predetermined pattern is printed on an original document beforehand, and upon detecting the pattern when reading the document, information including the user name of the user directing the execution of the corresponding imaging operation, the time/date of execution of the operation, and the machine unique number of the machine executing the operation, for example, may be superposed on the read document data. It is noted that the machine unique number corresponds to a number uniquely assigned to the MFP.

In the present embodiment, the superposed data may be output as printed paper in the case of a copying operation, scanned data of the original document in the case of a scanning operation, and data transmitted to a transmission destination in the case of a fax operation.

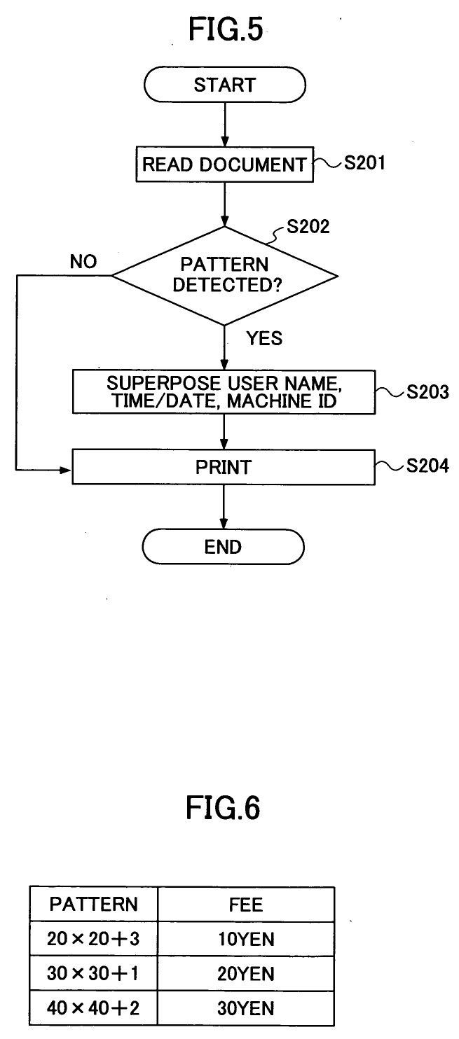

In the following, the process according to the present embodiment is described in relation to a copying operation as an example. FIG. 5 is a flowchart illustrating a process executed by the copier application 21. In the illustrated process, first, in step S201, an original document to be copied is read. Then, in step S202, a determination is made as to whether a pattern is detected. If no pattern is detected, a copy of the original document is printed in step S204.

If a pattern is detected in step S202, information including a user name, a time/date, and a machine ID, for example is superposed on the read data of the original document (step S203), and the superposed data are printed (step S204).

It is noted that in a case where the process of the present embodiment is applied to a scanner operation, the superposed data may be stored in the MFP in step S204; and in a case where the present process is applied to fax transmission, the superposed data may be transmitted to a transmission destination in step S204.

As can be appreciated from the above descriptions, by implementing the process of FIG. 5, when unauthorized copying of a document is performed, information pertaining to the time/date, the user name, and the MFP associated with such a copying operation may be determined from the corresponding copied document, for example.

In the following, a process according to another embodiment is described in which a fee pattern DB that registers patterns in association with their corresponding fees is provided so that an appropriate fee may be charged for an imaging operation by detecting a pattern upon reading an original document and obtaining the corresponding fee for the detected pattern.

FIG. 6 is a table illustrating an exemplary fee pattern DB. It is noted that the fee pattern DB corresponds to fee information according to a preferred embodiment of the present invention. In the illustrated fee pattern DB a pattern and its corresponding fee are stored as entry items. For example, it may be appreciated from the fee pattern DB shown in FIG. 6 that a fee of 20 yen is charged for a 30×30+1 pattern.

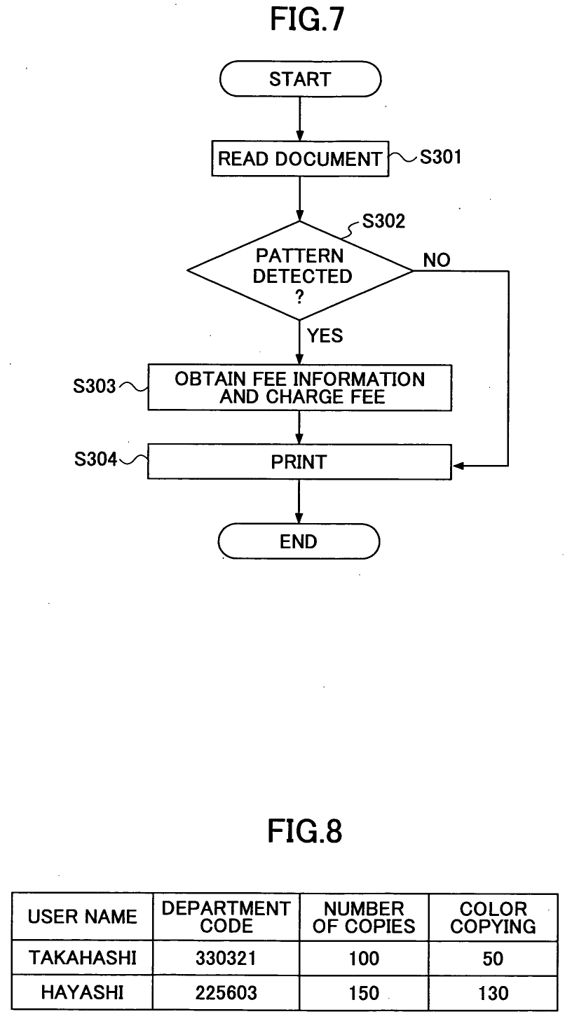

In the following, a process according to the present embodiment using the fee pattern DB is described in relation to a copying operation as an example. FIG. 7 is a flowchart illustrating a process executed by the copier application 21. In this process, first, in step S301, an original document to be copied is read. Then, in step S302, a determination is made as to whether a pattern is detected. If no pattern is detected, a copy of the original document is printed in step S304.

If a pattern is detected in step S302, fee information corresponding to the detected pattern is obtained from the fee pattern DB, and the corresponding fee is charged (step S303). Then, a copy of the original document is printed (step S304).

It is noted that in a case where the process of the present embodiment is applied to a scanner operation, step S304 may correspond to a step of storing the scanned data in the MFP; and in a case where the above process is applied to fax transmission, step S304 may correspond to a step of transmitting the scanned data to a transmission destination, for example.

By implementing the process of the present embodiment as is described above, fee calculation based on fee information may be performed for each document, and compilation of fee information may be simplified. Also, according to the present embodiment, fee information for copying/fax transmission may be compiled upon executing of the corresponding operation.

It is noted that the process shown in FIG. 7 may be modified to realize a process for keeping track of the number of copies made by a user, for example. In such a case, a user registration DB including a department code entry in addition to the entry items of the user registration DB shown in FIG. 3 may be used, and a corresponding department code of the department to which a user belongs may be stored in association with a corresponding user name, for example. In this case, when a pattern associated with a user name is detected from a document upon executing a copying operation, a relevant counter for the current copying operation may be incremented. It is noted that plural counters may be provided for different types of copying operations such as color copying and monochrome copying, for example.

FIG. 8 is a table illustrating counter information that may be obtained by the modified process as is described above. The counter information of FIG. 8 includes entry items indicated as ‘user name’, ‘department code’, ‘number of copies’, and ‘color copying’. It is noted that in the illustrated example, the entry ‘number of copies’ indicates the total number of copies made by a corresponding user, and the entry ‘color copying’ indicates the total number of color copies made by a corresponding user.

Although the present invention is shown and described with respect to certain preferred embodiments, it is obvious that equivalents and modifications will occur to others skilled in the art upon reading and understanding the specification. The present invention includes all such equivalents and modifications, and is limited only by the scope of the claims.

The present application is based on and claims the benefit of the earlier filing date of Japanese Patent Application No. 2005-045921 filed on Feb. 22, 2005, the entire contents of which are hereby incorporated by reference.

What is claimed is:

1. An imaging apparatus operated by an operator which apparatus is configured to execute an imaging operation involving reading an original document, the apparatus comprising:
a pattern detecting unit configured to determine whether a pattern is printed on the original document; and
user information registering an authorized user name of an authorized user that is authorized to direct the execution of the imaging operation in a case where the pattern is detected from the original document by the pattern detecting unit; wherein
the execution of the imaging operation is controlled in a case where the pattern is detected from the original document and the operator does not correspond to the authorized user with the authorized user name registered in the user information.

2. The imaging apparatus as claimed in claim 1, wherein
the user information registers a group name of a group of one or more of the authorized users as the authorized user name.

3. An imaging apparatus operated by an operator which apparatus is configured to execute an imaging operation involving reading an original document, the apparatus comprising:
a pattern detecting unit configured to determine whether a pattern is printed on the original document; and
a superposing unit configured to superpose information pertaining to the operator directing the execution of the imaging operation on read data obtained by reading the original document in a case where the pattern is detected from the original document by the pattern detecting unit.

4. An imaging apparatus configured to execute an imaging operation involving reading an original document, the apparatus comprising:
a pattern detecting unit configured to determine whether a pattern is printed on the original document; and
fee information registering the pattern in association with a corresponding fee; wherein
when the pattern is detected by the pattern detecting unit, the corresponding fee is obtained from the fee information and the corresponding fee is charged.

5. An imaging apparatus configured to execute an imaging operation involving reading an original document, the apparatus comprising:
a pattern detecting unit configured to determine whether a pattern is printed on the original document; wherein
when the pattern is detected from the original document by the pattern detecting unit, counter information including information pertaining to a number of executions of the imaging operation is changed.

6. The imaging apparatus as claimed in claim 5, wherein
the information pertaining to the number of executions of the imaging operation is associated with at least one type of the imaging operation.

7. The imaging apparatus as claimed in claim 5 wherein
the pattern detected by the pattern detecting unit is associated with a user name; and
the information pertaining to the number of executions of the imaging operation is associated with the user name.
